(19) United States
(12) Patent Application Publication
(10) Pub. No.: US 2005/0217911 A1
(43) Pub. Date: Oct. 6, 2005

(54) Protective grille for car radiator

(76) Inventor: Chiang-Lung Cheng, Yung Kang City (TW)

Correspondence Address: Leong C. LEI, PMB# 1008, 1867 Ygnacio Valley Road, Walnut Creek, CA, 94698, US

(21) Appl. No.: 10/812,898

(22) Filed: Mar. 31, 2004

(51) Int. Cl. B60K 11/04

(52) U.S. Cl. 180/68.6

(57) ABSTRACT

A protective grille for car radiator is disclosed. The protective grille has a main frame body having a hollow section forming into a side rim edge. A plurality of support rods, corresponding to the side rim edge, are linked and support the main frame body, and corresponding to the hollow section a metallic net-like protective grille is mounted. On the protective grille, corresponding to the side rim edge of the metallic net-like protective grille, is provided with a folded edge. The hollow section is mounted with the protective grille and a mounting belt surrounds the net body, the supportive rods, or an engaging grip is used to position the folded side and the main frame body. Thus, the protective grille for car radiator can be easily mounted.

### BACKGROUND OF THE INVENTION

(a) Technical Field of the Invention

The present invention relates to a car radiator protective grille, and in particular, to a protective grille having a main frame body corresponding and a mounting belt or an engaging grip for positioning.

(b) Description of the Prior Art

Protective grille 1 for a car radiator, as shown in FIG. 1, is made of plastic material, and is mounted at the external side of the car radiator. The protective grille 1 comprises a frame body 11 including a plurality of ribs 12. An engaging peg 13 is provided on the frame body 11 for mounting onto a car. The conventional protective grille has the following drawbacks:
(a) The conventional protective grille is made from plastic material which may be broken or damaged by slight impact.
(b) If the conventional protective grille is damaged, the entire grille has to be replaced which is not economical.
(c) The withstand force of the conventional protective grille is limited, therefore the grille cannot achieve the effect of protecting the car radiator.
(d) The mounting of the conventional protective grille is by way of engaging peg, which does not provide a safe positioning function and the plastic peg may be easily broken.
(e) Due to the fact that the conventional protective grille is made from plastic material, the aesthetic effect is poor.

Accordingly, it is an object of the present invention to provide a protective grille for car radiator which can mitigate the above drawbacks.

### SUMMARY OF THE INVENTION

Accordingly, it is an object of the present invention to provide a protective grille for car radiator having a main frame body, a metallic net-like protective grille and a mounting belt, characterized in that the main frame body is a framework having a hollow center section so that the frame edge of the framework is formed into a side rim edge and a plurality of support rods corresponding to the side rim edge are connected to and support the main frame body; the metallic net-like protective grille is provided with a plurality of net holes which is mounted in correspondence with the hollow center section, and a folded edge is provided to the rim edge of the main frame body; one end of the mounting belt is a positioning end corresponding to the net holes which surround the support rod through the positioning end; thereby the hollow center section of the main frame body is mounted with the protective grille, the mounting belt is correspondingly passed through the net holes, and the support rod.

Yet still another object of the present invention is to provide a protective grille for car radiator having a main frame body, a metallic net-like protective grille and an engaging grip, characterized in that the main frame body is a framework having a hollow center section so that the frame edge of the framework is formed into a side rim edge and a plurality of support rods corresponding to the side rim edge are connected to and support the mainframe body; the metallic net-like protective grille is provided with a plurality of net holes which is mounted in correspondence with the hollow center section, and a folded edge is provided to the rim edge of the main frame body; one end of the engaging grip is a grip end corresponding to the net holes which surround the support rod through the grip end; thereby the hollow center section of the main frame body is mounted with the protective grille, the engaging grip is correspondingly passed through the net holes, and the support rod.

Still another object of the present invention is to provide a protective grille for car radiator, wherein the strength of the entire protective grille is enhanced which may not be damaged easily.

Yet still another object of the present invention is to provide a protective grille for car radiator, wherein the aesthetic appearance of the head portion of the car is improved.

Yet a further object of the present invention is to provide a protective grille for car radiator, wherein the assembly of the protective grille is simple.

A further object of the present invention is to provide a protective grille for car radiator, wherein the shape of the net-like holes can be carried to match the shape of a car.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional protective grille for car radiator.

FIG. 2 is an exploded perspective view of the protective grille in accordance with the present invention.

FIG. 3 is a schematic view showing the action of the protective grille in accordance with the present invention.

FIG. 4 is a sectional view of the protective grille in accordance with the present invention.

FIG. 5 is a perspective exploded view of the present invention.

FIG. 6 is a sectional view of the protective grille of the present invention.

FIGS. 7 to 9 are preferred embodiments in accordance with the present invention.

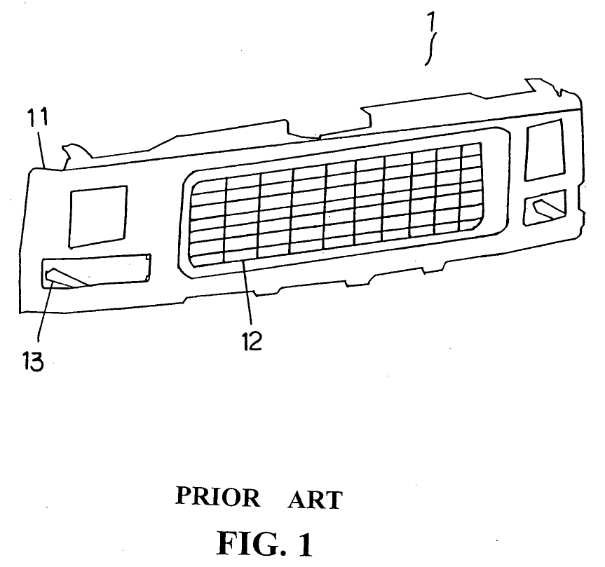

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

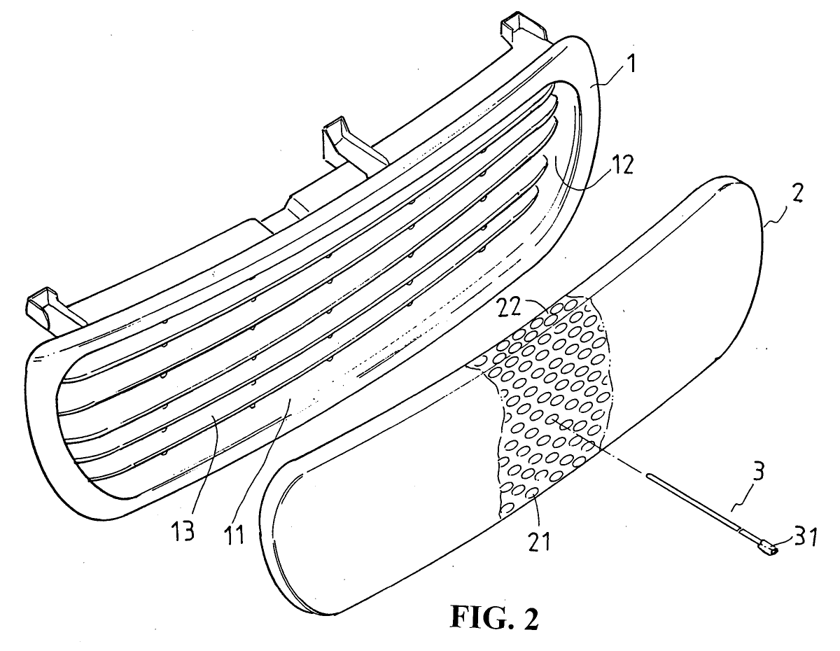

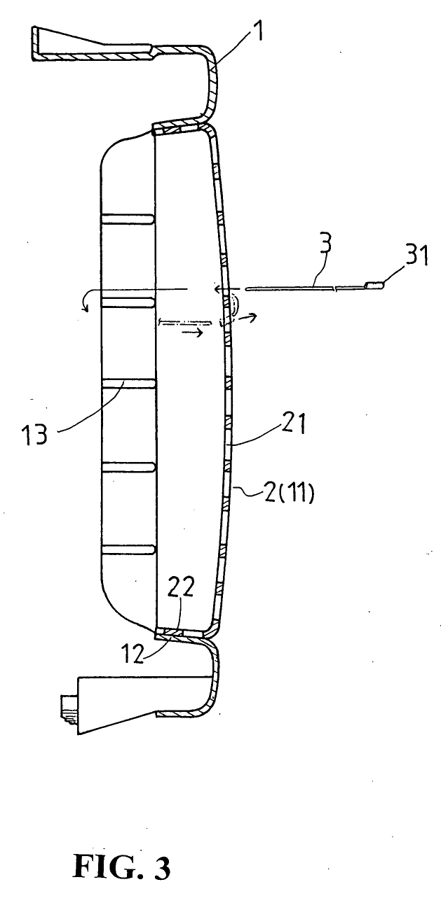

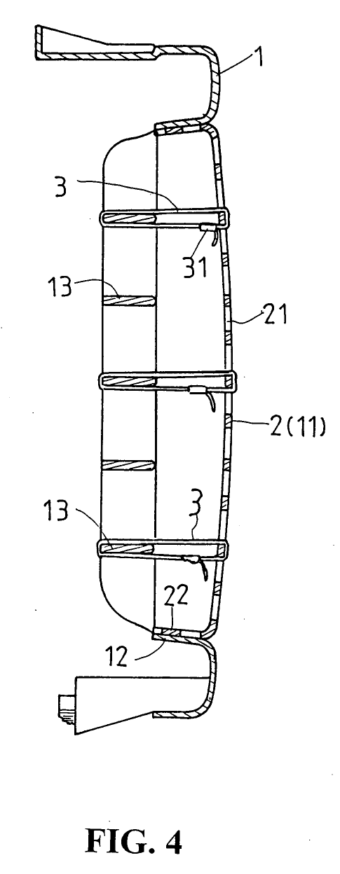

Referring to FIGS. 2 to 4, there is shown a protective grille for car radiator comprising a main frame body 1, a metallic net-like protective grille 2 and a mounting belt 3. The center of the main frame body 1 is a hollow section 11 and the hollow section 11 causes the edge of the framework to form into side rim edge 12. The two sides of the rim edge 12 are provided with a plurality of support rods 13 linked and supported the main frame body 1. The protective grille 2 is provided with a plurality of net holes 21 which are corresponding to the hollow section 11 of the main frame body 1. The protective grille 2 corresponding to the side rim edge 12 of the main frame body 1 is provided with a folded side 22. One end of the mounting belt 3 is formed into a positioning end 31 which is correspondingly passing through the net hole 21 of the protective grille 2 and surrounds the support rods 13 via the positioning end 31.

The entire hollow section 11 of the main frame body 1 is mounted with the metallic net-like protective grille 2 and the mounting belt 3 passing through the net hole 21, surrounding the support rod 13 and is positioned at the positioning end 31, preferably, six to eight mounting belt 3 are employed so that the protective grille is secured.

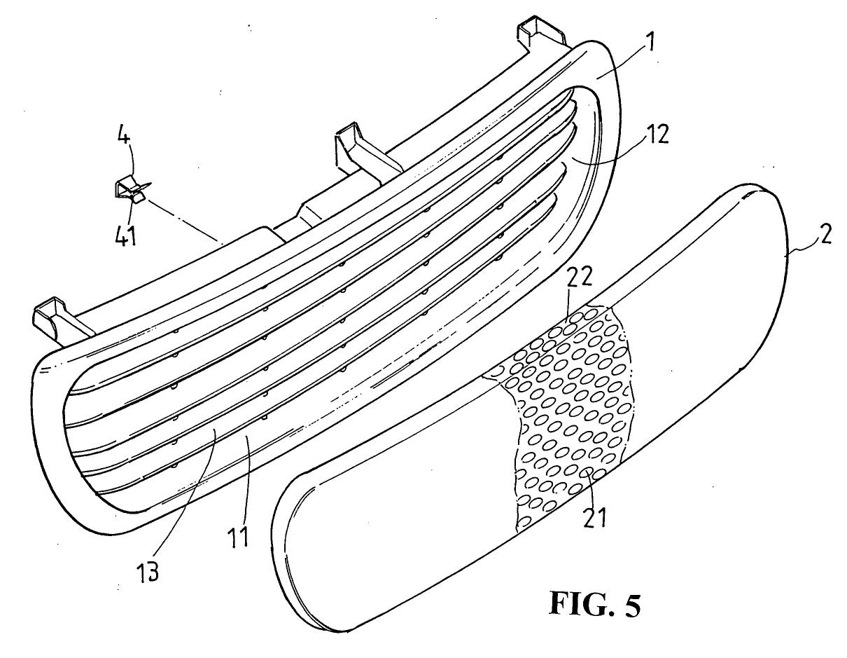

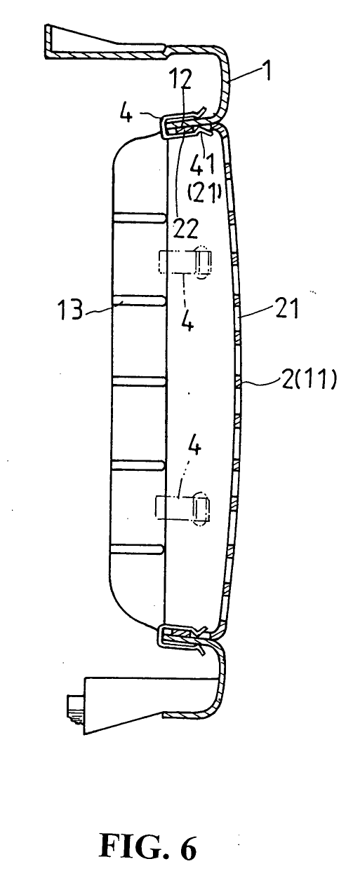

Referring to FIGS. 5 to 6, the protective grille is made for different types of car and comprises a main frame body 1, a metallic net-like protective grille 2 and an engaging clip 4. The center of the main frame body 1 is a hollow section 11 and the hollow section 11 causes the edge of the framework to form into side rim edge 12. The two side rim edge 12 are provided with a plurality of support rods 13 linked and supported the main frame body 1. The protective grille 2 is provided with a plurality of net holes 21 which is corresponding to the hollow section 11 of the main frame body 1. The protective grille 2 corresponding to the side rim edge 12 of the main fame body 1 is provided with a folded side 22.

The engaging grip 4 has a grip end 41 which is correspondingly engaged with the net-hole 21 of the folded side 22 of the grille 2, and the side rim edge of the main frame body 1, which is positioned thereto.

The hollow section 11 of the main frame body is mounted with the metallic net-like protective grille 2, and the engaging grip 4 is corresponding to the net hole 21 of the folded edge 22 and the side rim edge 12 of the main frame body 1 such that the engaging grip end 41 of the engaging grip 4 can engage with the interior of the net hole 21 of the folded side 22 (preferably six to eight of the engaging grip 4 are employed). Thus, the protective grille is conveniently and firmly positioned.

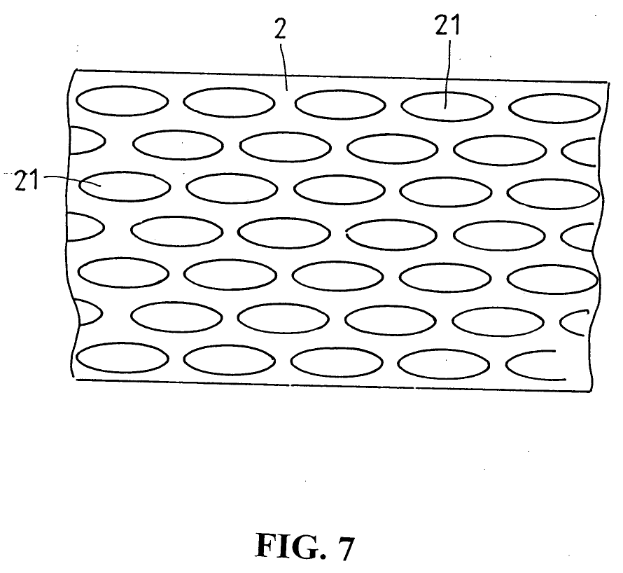

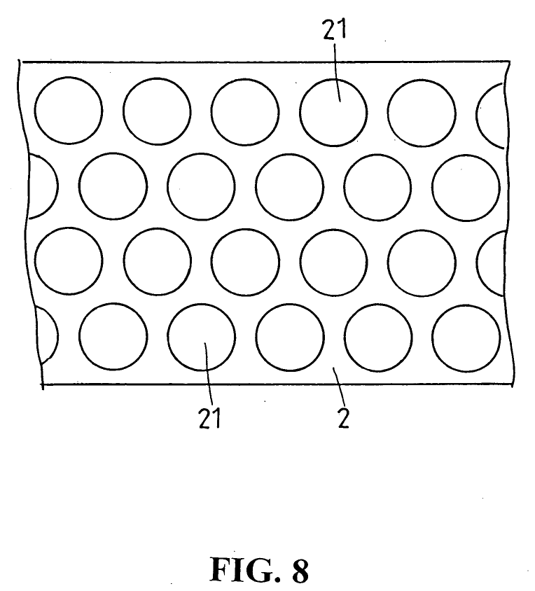

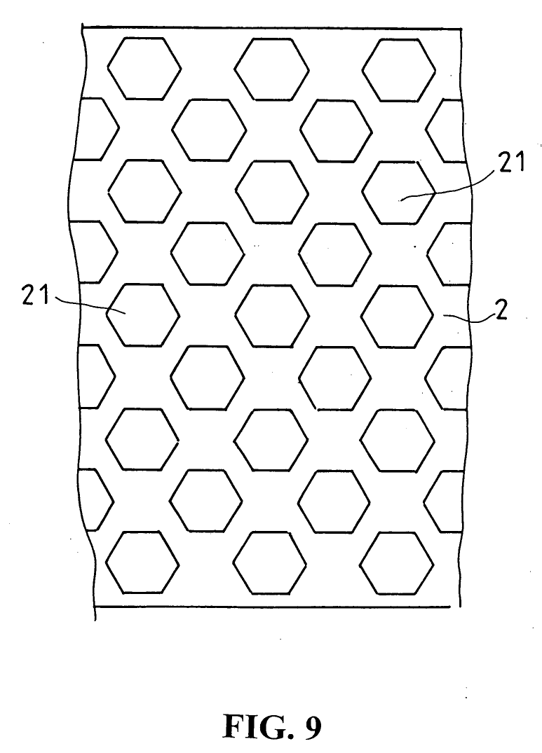

Referring to FIGS. 7-9, there is shown various protective grilles for car radiator and the net hole 21 of the protective grille 2 can have diamond shape, circular, hexagonal or oval shape.

The advantages of the present protective grille for car radiator are:
(a) the strength of the entire protective grille is enhanced which may not be damaged easily;
(b) the aesthetic appearance of the head portion of the car is improved;
(c) the assembly of the protective grille is simple; and
(d) the shape of the net-like holes can be carried to match the shape of a car.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A protective grille for car radiator having a main frame body, a metallic net-like protective grille and a mounting belt, characterized in that
the main frame body is a framework having a hollow center section so that the frame edge of the framework is formed into a side rim edge and a plurality of support rods corresponding to the side rim edge are connected to and support the main frame body; the metallic net-like protective grille is provided with a plurality of net holes which is mounted in correspondence with the hollow center section, and a folded edge is provided to the rim edge of the main frame body; one end of the mounting belt is a positioning end corresponding to the net holes which surround the support rod through the positioning end;
thereby the hollow center section of the main frame body is mounted with the protective grille, the mounting belt is correspondingly passed through the net holes, and the support rod.

2. A protective grille for a car radiator having a main frame body, a metallic net-like protective grille and an engaging grip, characterized in that
the main frame body is a framework having a hollow center section so that the frame edge of the framework is formed into a side rim edge and a plurality of support rods corresponding to the side rim edge are connected to and support the mainframe body; the metallic net-like protective grille is provided with a plurality of net holes which is mounted in correspondence with the hollow center section, and a folded edge is provided to the rim edge of the main frame body; one end of the engaging grip is a grip end corresponding to the net holes which surround the support rod through the grip end;
thereby the hollow center section of the main frame body is mounted with the protective grille, the engaging grip is correspondingly passed through the net holes, and the support rod.
